(19) United States
(12) Patent Application Publication
(10) Pub. No.: US 2006/0227729 A1
(43) Pub. Date: Oct. 12, 2006

(54) Wireless communication system with collision avoidance protocol

(75) Inventors: Ramakrishna S. Budampati, Plymouth, MN (US); Patrick S. Gonia, Maplewood, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/103,982

(22) Filed: Apr. 12, 2005

(51) Int. Cl. H04L 12/413; H04B 7/005

(52) U.S. Cl. 370/278; 370/445

(57) ABSTRACT

A system of wireless infrastructure nodes are communicatively coupled to a number of internally powered leaf nodes. The leaf nodes may have sensors and/or actuators. A wireless leaf node transmits data to an infrastructure node at a time according to a duty cycle. When a collision occurs, the data is retransmitted until an acknowledgement is received from an infrastructure node. A change in a transmission protocol parameter, such as duty cycle/phase of sampling is initiated with such retransmissions. A decision to change the parameter is taken either by the wireless leaf node itself, or by an infrastructure node. Some of the leaf nodes can be transmit-only devices which repeat each data packet a number of times.

### FIELD OF THE INVENTION

The invention relates to wireless communication systems and in particular to a wireless communication system with a collision avoidance protocol.

### BACKGROUND

Wireless sensors are usually powered by batteries. The batteries have a useful life that is limited, and is a function of the transmission power of the sensor coupled with the number of times that a sensor needs to transmit data. In some sensor networks, transmissions of data from a sensor may collide with transmissions from other sensors. The sensor may then retransmit the data additional times in order for the data to be properly received. Some of these sensors may be transmit-only devices that transmit each data packet a number of times. There is a need for a wireless sensor network that reduces the number of transmissions required by wireless sensors or other types of wireless nodes, referred to as leaf nodes. There is a need to extend the battery life of wireless leaf nodes to reduce maintenance costs.

### SUMMARY

A wireless leaf node transmits data to an infrastructure node at a time according to a duty cycle. When a collision occurs, the data is retransmitted until an acknowledgement is received from an infrastructure node. A change in a transmission protocol parameter, such as duty cycle/phase of sampling is initiated with such retransmissions. A decision to change the parameter is taken either by the wireless leaf node itself, or by an infrastructure node.

In one embodiment, some of the leaf nodes may be transmit-only devices which repeat each data packet a number of times. The parameters for the transceiver leaf nodes may be changed in such a way that their future transmissions do not collide with the transmissions from the transmit-only leaf nodes.

### BRIEF DESCRIPTION OF THE DRAWING

FIG. 1 is a block diagram of a wireless communication system according to an example embodiment of the present invention.

FIG. 2 is a block diagram of a wireless communication system according to an alternative example embodiment of the present invention.

FIGS. 3A and 3B are a block diagram and a timing diagram of a wireless communication system according to an example embodiment of the present invention.

### DESCRIPTION

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

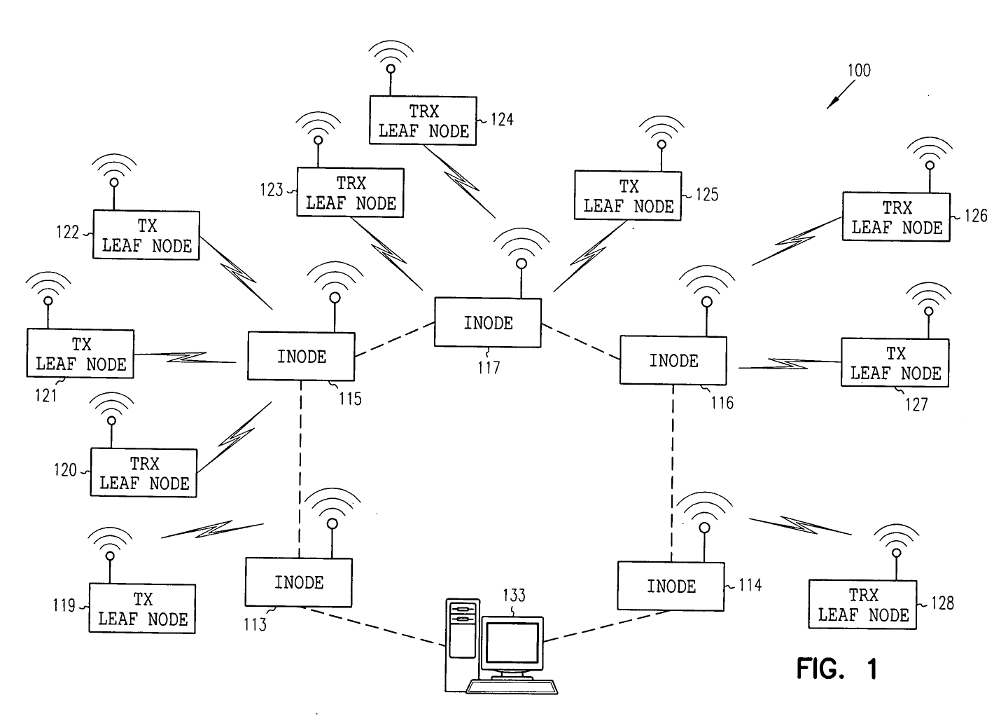

Wireless sensors and actuators have become very attractive due to ease of installation and wiring and labor cost savings. In one embodiment, wireless communication systems such as the system 100 illustrated in block diagram form in FIG. 1 allow the deployment of wireless devices in desired locations and may increase overall coverage area.

Infrastructure nodes in one embodiment are transceivers that may be placed in various locations such as in an industrial plant or in a field to cover areas and the infrastructure nodes are linked to each other via wireless or wired links. In one embodiment, infrastructure nodes (Inodes) may capture wireless communications from multiple leaf nodes that are located within communication range of the infrastructure nodes. The leaf nodes may be internally or battery powered wireless sensors and actuators. Various communication protocols may be implemented allowing wireless communications between the nodes. In one embodiment, frequency spreading/frequency hopping protocols may be used.

In one embodiment, there are at least two types of leaf nodes. One type of leaf node is referred to as a TX leaf node indicated at 119, and is communicating with Inode 113. TX leaf node 119 is a transmit only leaf node, which transmits signals to the Inode 113. In one embodiment, it may transmit a signal with the same information several times to ensure that it has been received. Since it does not have a receiver, it cannot receive any sort of acknowledgement from Inode 113.

A second type of leaf node 120 is referred to as a TRX leaf node, because it contains a transceiver, allowing two way communication between Inode 115. In one embodiment, the communication connection is wireless, and allows the Inode to receive data from the TRX leaf node, and allows the TRX leaf node to receive acknowledgements from the Inode.

In FIG. 1, a plurality of Inodes and various leaf nodes are shown. In further embodiments, the numbers of such nodes may be greatly varied. Example system 100 has Inode 113 coupled to TX leaf node 119, Inode 115 coupled to TRX leaf node 120, and TX leaf nodes 121 and 122. Inode 117 is coupled to TRX leaf nodes 123 and 124 and TX leaf node 125. Inode 116 is coupled to TRX leaf node 126 and TX leaf node 127, and Inode 115 is coupled to TRX leaf node 128.

In one embodiment, infrastructure nodes forward sensor data from a leaf node to data recipient hardware, such as a control room, central station, and/or a computer 133. Infrastructure nodes 113 and 114 may be gateway nodes that are hard-wired to a bus or may be wirelessly connected. There may be just one infrastructure gateway node or more than two such nodes.

Infrastructure nodes 115, 116 and 117 may be line powered and capable of significant wireless range and good reliability in the delivery of information. However, the desired wiring cost savings and flexibility of placement of sensors (leaf nodes) makes it almost necessary to use wireless sensors like leaf nodes 119-128. These leaf nodes may be low power, low cost and low complexity radios that operate with battery power.

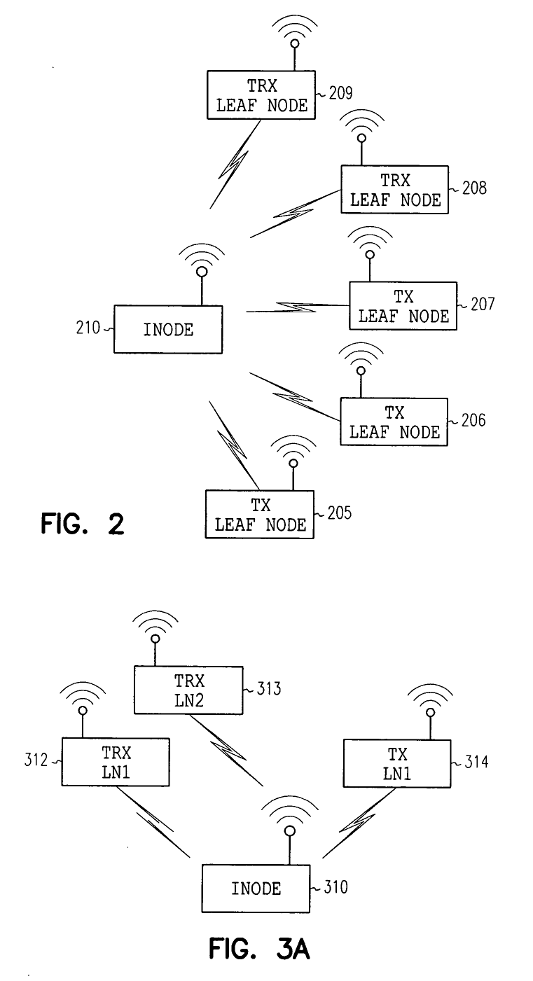

FIG. 2 is a block diagram showing one alternative arrangement of leaf nodes 205, 206, 207, 208 and 209 communicating with an Inode 210. TX leaf nodes 205 and 206 are transmit only leaf nodes, while TRX leaf nodes 207, 208 and 209 are transceiver leaf nodes. Each type of leaf node may transmit packets in accordance with a transmission protocol parameter. The Inode may save the transmission protocol parameters for each leaf node it communicates with. In one embodiment, the transmission protocol parameter comprises a phase of sampling/duty cycle.

In one embodiment, Inode 210 only sends an acknowledgement (ACK) to TRX leaf nodes. TRX leaf nodes may include an indication in transmitted packets to request an ACK from the INode. TX leaf nodes may have an indication in their transmitted packets to not request an ACK from the INode. In further embodiments, only one type of leaf node indicates its preference for an ACK, and the Inode infers the opposite for other leaf nodes note indicating a preference. In still further embodiments, the Inode keeps track of which leaf nodes should receive ACKs, and responds accordingly. The INode may have the ability to look at the indication in a received packet and decide to transmit or not transmit an ACK.

The TRX Leaf Node has a retransmit module that retransmits a packet when no ACK is received. The retransmit module may include a request for a shift of the transmission protocol parameter in each retransmission. The retransmit module shifts the transmission protocol parameter consistent with the request in the retransmission which received an ACK with a response to the request.

In one embodiment, the INode has a response module that sends the ACK with the response to the request for the shift of the transmission protocol parameter. The response module shifts the transmission protocol parameter consistent with the request and updates the list of the transmission protocol parameters.

The retransmit module of the TRX leaf node may set a flag indicative of a collision in each retransmission. The retransmit module shifts the transmission protocol parameter consistent with a command received in an ACK to a retransmission. In still further embodiment, the INode response module sends the ACK after receiving a retransmission with a flag indicative of a collision. The ACK includes a command to shift the transmission protocol parameter for succeeding packets. The response module shifts the transmission protocol parameter consistent with the command and updates the list of the transmission protocol parameters.

In a typical wireless sensor network, multiple leaf nodes may be associated with each infrastructure node. In order to conserve power by reducing their complexity, the leaf nodes may not be time synchronized with each other or with the associated infrastructure node. Due to such lack of synchronization, collisions between the transmissions of different leaf nodes are likely to occur. If a collision occurs, the infrastructure node will not transmit the ACK, so the TRX leaf node re-transmits the same data until it hears the ACK from the infrastructure node. Such re-transmissions will require additional batter power consumption, thus significantly reducing the overall life of the battery-powered leaf node.

Medium access control is a technique used to avoid collisions so that two interfering TRX leaf nodes do not repeatedly transmit at the same time. Collision avoidance may greatly reduce the number of re-transmissions required. Such collision avoidance may save battery power at the leaf node, thus increasing the overall life of the wireless sensor network. The medium access control technique is described in further detail below.

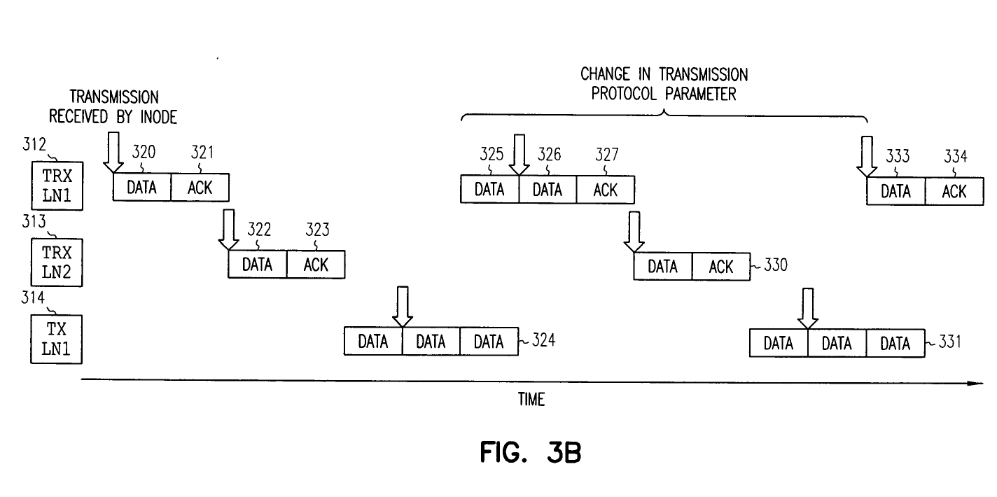

In one example embodiment illustrated in FIGS. 3A and 3B, an Inode 310 is coupled to two TRX leaf nodes, 312 and 313, and a TX leaf node 314. FIG. 3A is a block diagram representation of the Inode and leaf nodes in communication. FIG. 3B illustrates a timing diagram for communications between the leaf nodes and the Inode, including the use of medium access control to avoid further collisions.

In FIG. 3B, TRX leaf node 312 transmits a packet as indicated at 320 during a first leaf node phase of a sampling/duty cycle. TRX leaf node 312 will receive an ACK 321 from Inode 310. TRX leaf node 313 then transmits a packet 322 and receives an ACK 323. Next, TX leaf node 314 begins to transmit data at 324. Note that since no ACK is sent, nor can it be received in one embodiment, the same data is transmitted several times. While the data is being transmitted for the third time, TRX leaf node 312 begins to transmit data 325. A collision occurs due to the overlap in transmissions. Since no ACK is received in response to transmission of data 325, TRX leaf node 312 retransmits it at 326, setting a retransmit flag, and receives an ACK at 327 with a new transmission protocol value.

TRX leaf node 313 then sends a packet and receives an ACK at 330 during its next phase, and TX leaf node 314 transmits data several times at 331. TRX leaf node 312 received the previous ACK 327, which included the new transmission protocol value. It modified its transmission to the new phase, and transmits data 333. Since data 333 did not collide with data 331 from TX leaf node 314, data 333 is received by the Inode and an ACK 334 is sent by the Inode and received by the TRX leaf node 312. A complete cycle of data transfer from leaf nodes coupled to Inode 310 occurred, and no further transmission protocol values are changed. However, since some TX leaf nodes transmit relatively infrequently, and clock values in different leaf nodes may change, it may later be necessary to repeat the process of medium access control.

Avoiding collisions may help reduce the number of retransmissions required of battery powered leaf nodes. It can result in substantial extension of battery life, leading to lower maintenance costs. When a TRX leaf node, such as a sensor nodes not receive an ACK, it will re-transmit the packets again. If it does not change its transmission protocols, this sequence is bound to repeat each time the sensor wakes up to transmit data in accordance with the protocol, always requiring two transmissions per packet to receive an ACK. By avoiding these repetitive collisions by shifting its transmission protocol parameters, such as duty cycle/phase of sampling, it can send future packets using only one transmission per packet. The decision to change the protocol parameter is taken either by the sensor itself, or by the associated infrastructure node. Battery power consumption is reduced, thus increasing the overall life of a wireless sensor network.

In some instances, the first retransmission of a packet will also collide with a packet from another leaf node. In this case, it repeats re-transmission of the packet until the nth transmission receives ACK(s), and permission to change. This would correspond to the earliest collision-free transmission using the current phase of sampling. The nth transmission contains the packet and the requested new phase corresponding to the nth transmission of the old cycle. The infrastructure node(s) would not grant permission if the new phase might result in future collisions, or another leaf node is also interested in following the same phase.

Where the change in phase of sampling is initiated by the infrastructure node, the leaf node updates a previous collision flag in the retransmitted packet. Where a frequency hopping communication protocol is used, the infrastructure node follows the frequency hopping sequence and duty cycle, and knows about the collisions. This fact is reiterated by the collision flag in the received retransmitted packet. The infrastructure node proposes a new phase for the leaf node, while taking into consideration the phases of all the other associated leaf nodes. It transmits this new phase proposal with the ACK. The leaf node receives the proposal and changes its phase of sampling and it may send a confirmation ACK back to the infrastructure node. It follows the new phase from the next packet onward until a new collision is detected. At this point, the phase change process may repeat.

Leaf nodes generally need not have a fixed application duty cycle. They may opt to dynamically change the application duty cycle on a per-wake-up basis by sending the next wake-up time to the infrastructure node or infrastructure node may indicate the next wake-up time for the leaf nodes in the ACK. This information may be enough for the infrastructure node to track the leaf node's activity.

Although the invention has been described with respect to at least one illustrative embodiment, many variations and modifications will become apparent to those skilled in the art upon reading the present specification. Various communication protocols may be used. Many different configurations of infrastructure and leaf nodes may be used, including different types of leaf nodes in the same network, or networks utilizing a single type of leaf node. It is therefore the intention that the appended claims be interpreted as broadly as possible in view of the prior art to include all such variations and modifications.

What is claimed is:

1. A wireless communication system consisting of:
a plurality of transceiver based wireless devices that may have a wireless transceiver for transmitting packets and receiving acknowledgments (ACKs);
a plurality of transmitter based wireless devices that may have a wireless transmitter for transmitting packets;
a plurality of infrastructure wireless devices that may have a wireless transceiver for receiving packets and transmitting ACKs; wherein
each infrastructure wireless device may be associated to a few transceiver wireless devices and a few transmitter wireless devices;
each associated transceiver wireless device may transmit packets to the infrastructure wireless devices using a transmission protocol parameter;
each associated transmitter wireless device may transmit packets to the infrastructure wireless device using a transmission protocol parameter;
each infrastructure wireless device maintains a list of the transmission protocol parameters for each associated transceiver and transmitter wireless device; and
each infrastructure wireless device may receive the transmitted packets from the associated transceiver and transmitter wireless devices using the list of the transmission protocol parameters.

2. The system of claim 1 wherein:
the transceiver wireless devices have an indication in the transmitted packets to request an ACK from the infrastructure wireless device;
the transmitter wireless devices have an indication in the transmitted packets to not request an ACK from the infrastructure wireless device; and
the infrastructure wireless device has the ability to look at the indication in a received packet and decide to transmit or not transmit an ACK.

3. The system of claim 2 wherein:
the transceiver wireless devices can detect collisions of the current transmitted packet with other wireless devices' transmitted packets, and shift a transmission protocol parameter for subsequent packets based on the detected collisions;
the transmitter wireless devices transmit the same packet multiple times; and
the infrastructure wireless devices can detect collisions of the current transmitted packet and adjust to the shift in the transmission protocol parameter by the transceiver wireless devices.

4. The system of claim 3 wherein the transmission protocol parameter that is shifted comprises a phase of sampling/duty cycle.

5. The system of claim 3 wherein the transceiver wireless device has a module that retransmits a packet when no ACK is received.

6. The system of claim 5 wherein:
the module includes a request for the shift of the transmission protocol parameter in each retransmission; and
the module shifts the transmission protocol parameter consistent with the request in the retransmission which received an ACK with a response to the request.

7. The system of claim 6 wherein:
the infrastructure wireless device has a response module that sends the ACK with the response to the request for the shift of the transmission protocol parameter; and
the response module shifts the transmission protocol parameter consistent with the request and updates the list of the transmission protocol parameters.

8. The system of claim 5 wherein the module sets a flag indicative of a collision in each retransmission and shifts the transmission protocol parameter consistent with a command received in an ACK to a retransmission.

9. The system of claim 8 wherein:
the infrastructure wireless device has a response module that sends the ACK after receiving a retransmission with a flag indicative of a collision; and
the ACK includes a command to shift the transmission protocol parameter for succeeding packets.

10. The system of claim 9 wherein the infrastructure wireless device shifts the transmission protocol parameter based on the list of the transmission protocol parameters for all the other transmitter and transceiver wireless devices.

11. The system of claim 9 wherein the response module shifts the transmission protocol parameter consistent with the command and updates the list of the transmission protocol parameters.

12. A leaf node in a communication system having leaf nodes and infrastructure nodes, the leaf node comprising:
a wireless transceiver that detects collisions of current packets with other leaf nodes, and shifts a transmission protocol parameter for succeeding packets as a function of the detected collisions.

13. The leaf node of claim 12 wherein the transmission protocol parameter that is shifted comprises a phase of sampling/duty cycle.

14. The leaf node of claim 12 wherein:
the leaf node wireless transceiver receives acknowledgements (ACKs) from the infrastructure nodes in response to a transmission; and
the leaf node wireless transceiver has a module that retransmits a packet when no ACK is received.

15. The leaf node of claim 14 wherein the module includes a request for the shift of the transmission protocol parameter in each retransmission and shifts the transmission protocol parameter consistent with the request in the retransmission which received an ACK.

16. The leaf node of claim 14 wherein the leaf node module sets a flag indicative of a collision in each retransmission and shifts the transmission protocol parameter consistent with a command received in an ACK to a retransmission.

17. A method of transmitting packets implemented in a leaf node in a communication system having leaf nodes and infrastructure nodes, the method comprising:
transmitting a leaf node originated packet;
determining that no acknowledgement of the transmitted packet was received;
re-transmitting the leaf node originated packet with a request to use a new transmission protocol parameter for transmitting future packets;
receiving an acknowledgement; and
transmitting future packets using the new transmission protocol parameter.

18. The leaf node of claim 17 wherein the transmission protocol parameter comprises a phase of sampling/duty cycle.

19. The method of claim 17 wherein the received acknowledgement includes a permission to use the new transmission protocol parameter for transmitting future packets.

20. The method of claim 17 wherein the new transmission protocol parameter is not used unless the received acknowledgement grants permission to use the new phase for transmitting future packets.
